(19) United States
(12) Patent Application Publication
(10) Pub. No.: US 2009/0120910 A1
(43) Pub. Date: May 14, 2009

(54) Interrupter Unit of an Electrical Switching Device

(75) Inventors: Thomas Chyla, Berlin (DE); Volker Lehmann, Treuenbrietzen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/298,314

(22) PCT Filed: Mar. 30, 2007
(86) PCT No.: PCT/EP2007/053096

§ 371 Date: Oct. 24, 2008

(30) Foreign Application Priority Data
Apr. 24, 2006 (DE) 10 2006 019 383.0

(51) Int. Cl. H01H 33/70

(52) U.S. Cl. 218/84

(57) ABSTRACT

An interrupter unit of an electrical switching device has a flow-conducting body. Gases which are flowing away are guided by way of the flow-conducting body. The flow-conducting body is formed at least from a first and a second element, wherein a joint gap is formed between the two elements. The joint gap has a section, which is formed with a complementary shape between the two elements so as to form a labyrinth structure.

The invention relates to an interrupter unit of an electrical switching device having a flow-conducting body for guiding a gas dispersing in a first direction, the flow-conducting body being assembled from at least a first and a second element while forming a joint gap.

An interrupter unit of this kind having a flow-conducting body is disclosed, for example in the patent specification U.S. Pat. No. 3,984,651. Here, the flow-conducting body is formed from a plate-shaped element and a bolt-shaped element, wherein the bolt-shaped element presses the plate-shaped element against a plinth. A joint gap is formed between the two elements.

Due to the design, heated gases are produced when an arc is extinguished. These gases are thrown against the flow-conducting body and are guided thereby into specific areas. This must happen in as defined a way as possible in order either to prevent turbulence or to produce turbulence in a deliberate manner. Due to high flow velocities, the gases also penetrate joints. As a result of the temperature and the flow velocities of the gases, the joints can erode so that the mechanical stability can be adversely affected.

The object of the invention is therefore to provide the embodiment of an interrupter unit with a flow-conducting body of the kind mentioned in the introduction in such a way that the unit is not susceptible to hot gases.

According to the invention, the object is achieved for an interrupter unit of the kind mentioned in the introduction in that the joint gap has a section in which the two elements are formed with a complimentary shape while forming a labyrinth structure.

The complimentary-shaped design of the elements enables the assembly times to be reduced, as the position of the elements with respect to one another is clearly defined by the embodiment of the shape of the elements. Furthermore, the labyrinth structure of the joint gap enables a penetrating gas to be retarded as a result of repeated redirection within the joint gap. Furthermore, the gas is cooled by the redirection and collision with walls of the joint gap. The effect of the hot gas within the joint gap is reduced to a permissible level as a result of the labyrinthine joint gap. This therefore prevents a corrosion/erosion inside the joint gap, which could lead to the two elements of the flow body being driven apart.

Furthermore, it can advantageously be provided that the section is formed at least partially by a projection of the first element, which is surrounded by walls of the second element.

The projection enables a labyrinthine structure of the gap to be easily produced. A labyrinthine structure is understood to mean that the gap is redirected several times by approximately 45 to 110°, preferably by 90°. The design of the joint gap should be chosen so that gas penetrating the joint gap flows at least once in the opposite direction to the first direction. The redirection takes place alternately in different directions. In this way, a meandering of the gap is achieved. Furthermore, this has the advantage that the gap assumes a comparatively great length with regard to a sectional plane in a compact structural space. In turn, this increased gap length makes it possible to effectively cool and expand the switching gas in the joint gap.

The projection of the first element can for example be designed in the form of a shoulder, wherein the shoulder engages in a slot provided in the second element when the first element is joined to the second element.

A further advantageous embodiment can provide that the first and the second element are rotationally symmetrical bodies.

For dielectric reasons, interrupter units of electrical switching devices, which are used in the medium, high and highest voltage range, i.e. in the range above 1,000 V, in particular in the range 10,000 V to 200,000 V, 500,000 V and 1.1 MV must be designed to be as free as possible from peaks and edges. Even small projections or edges can lead to partial discharges and thus damage insulation. A rotationally symmetrical flow-conducting body can be designed to be hollow, for example, so that a dielectric screening effect of the flow-conducting body can also be utilized as well as the flow-conducting effect of the flow-conducting body. In this way it is possible for further assemblies, which, for example, have a disadvantageous dielectric embodiment, to be arranged in the shadow of the screen. When a rotationally symmetrical flow-conducting body is used, it is advantageous when the joint gap is likewise arranged rotationally symmetrically circumferentially about the axis of rotation of the flow-conducting body. At the edge of the joint gap, the joint gap should be arranged essentially perpendicular, that is to say radially, to the first direction.

A further advantageous embodiment can provide that, in the section, the course of the joint gap is redirected by at least 180°.

An advantageous embodiment of the section with the labyrinth structure is provided when the joint gap is redirected by at least 180°, that is to say through a double redirection of 90° in the same direction. As a result of a redirection of this kind, gas penetrating the joint gap is retarded and forcibly fed back in the opposite direction. This provides effective cooling and expansion of the hot gas in the area of the 180° redirection.

A further advantageous embodiment can provide that the joint gap has a lower thickness before and after the redirection than in the area of the at least 180° redirection.

The expansion and cooling of the gas can be further assisted by a special embodiment of the area of the at least 180° redirection. The gap should have a larger cross-section in the area of the redirection. As a result, the extinguishing gas in this area of the gap is expanded in order to subsequently flow into a following zone with increased flow resistance. The gas is retarded in a pulsed or wavelike manner due to the varying flow resistances.

Because of the 180° redirection, the section is provided with a structure in which the joint gap has identically aligned sections, through which switching gas flows in different directions when the switching gas flows in. Advantageously, these areas should be chosen to be approximately parallel or coaxial to the direction of flow (first direction) of the dispersing gas, which prevails at the outer circumference of the flow-conducting body.

It is particularly advantageous when a double redirection of the joint gap by at least 180° occurs with respect to a sectional plane. This produces a double S-shaped structure in which several sections of the joint gap are aligned approximately parallel with one another.

A further advantageous embodiment can provide that one of the elements guides a movable contact piece of the interrupter unit.

Because of the restricted space conditions in most electrical switching devices, it is advantageous when a flow-conducting body also undertakes other tasks as well as the flow-conducting task. In this case, it is particularly favorable to use this as an auxiliary structure for positioning further assemblies of the interrupter unit. Several contact pieces of an interrupter unit are often movable relative to one another. By guiding a movable contact piece, further complex holding mechanisms for the movable contact piece can be dispensed with. In particular, when dielectric screening characteristics of the elements are used, electrical contact can be made with the contact piece, for example in the screen area of an element. For example, flexible strips between the movable contact piece and a fixed contact point can be used to make electrical contact. However, it can also be provided that elastic contact fingers are attached to a fixed contact point and form a sliding contact arrangement with the movable contact piece. With a rotationally symmetrical embodiment of the interrupter unit, it can be advantageous when the movable contact piece is designed in the form of a bolt and is mounted so that it can be moved along the longitudinal axis of the bolt. An appropriate bush, which guides the movable contact piece, can then be arranged on the element for guiding the movable contact piece.

A further advantageous embodiment can provide that one element is formed essentially from an electrical insulator and one element is formed essentially from an electrically conducting material.

On the one hand, using different materials for the two elements of the flow-conducting body enables the mass of the flow-conducting body to be reduced. The use of an electrical insulator, preferably a synthetic material such as polytetrafluoroethylene for example, which gives off hard gas, can effect additional cooling of the dispersing gases. When an electrically conducting material is used for the other element, this can act as a screening body. The material mix therefore allows a reduced-mass flow-conducting body to be formed, which also acts as a dielectric screen.

A further advantageous embodiment can provide that, in the section, the joint gap undergoes a double redirection by at least 180°.

An at least double redirection of the joint gap allows the gap to be provided with an increased length in a short space, and to force a frequent redirection of the gas flowing into the joint gap.

A further advantageous embodiment can provide that the first element is connected to a carrier element while interposing a contact piece, wherein the second element is held positively locked between carrier element and first element by the joint gap.

The positively locked insertion of a contact piece between one element and a carrier element enables a connection to be easily made to the movable contact piece. The interposed contact piece can for example be designed in the form of a tulip-shaped contact piece, which has a plurality of contact fingers, wherein the contact fingers are positioned around and in contact with a preferably movable contact piece designed in the form of a bolt. This makes it possible to connect the movable contact piece to a fixed contact point of the interrupter unit. Advantageously, this arrangement should be arranged within a screen area, which is created by the flow-conducting body. This enables the contact piece to be optimized with regard to its function and be dielectrically screened by the flow-conducting body.

In order to press the contact piece firmly between the elements, the joint gap can be used to compensate for manufacturing tolerances. As a result of this, the joint gap can be variable in its cross section. With a disadvantageous product, i.e. with a larger variation of tolerances, a bigger joint gap can be produced so that a greater quantity of gas can flow into the joint gap. However, because of the labyrinth structure, the occurrence of an expansion or corrosion or degradation of the joint gap, and therefore of the effectiveness of the flow-conducting body, is also reliably prevented in this case.

Furthermore, it can advantageously be provided that the second element is held floating in the positive lock.

As a result of a floating positively locked connection of the second element, as well as its flow-conducting function this can also provide a kind of sealing effect between the carrier element and the first element. Particularly when the second element is made from a synthetic material, tolerances can be compensated for in an improved manner.

An exemplary embodiment of the invention is shown schematically in drawings and described in more detail below.

In the drawings:

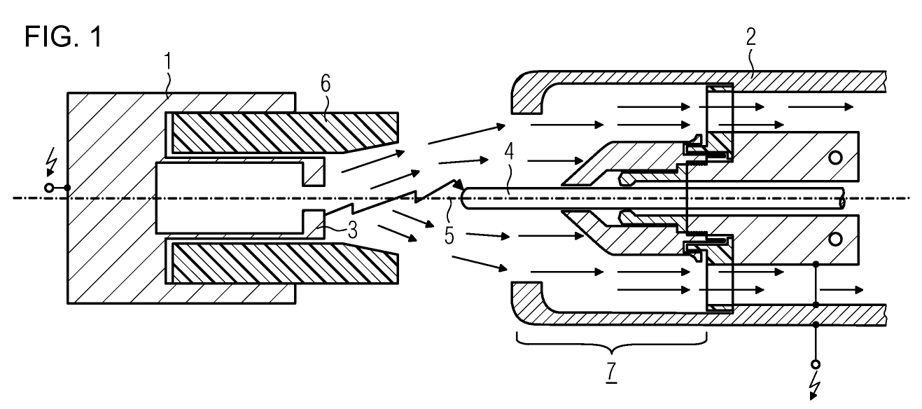

FIG. 1 shows a section through an interrupter unit of a high-voltage circuit breaker, and

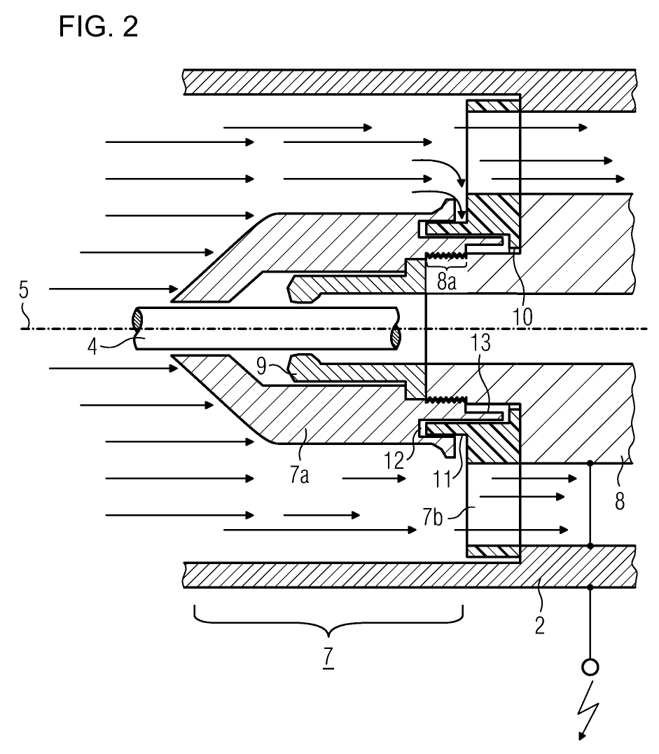

FIG. 2 shows a detail from FIG. 1 with a flow-conducting body.

A section through an interrupter unit of a high-voltage circuit breaker is shown in FIG. 1. The sectional plane runs through an axis of rotation 5 of the interrupter unit. The interrupter unit has a first rated current contact piece 1 and a second rated current contact piece 2. The interrupter unit also has a first arc contact piece 3 and a second arc contact piece 4. The first rated current contact piece 1 and the first arc contact piece 3 and the second rated current contact piece 2 and the second arc contact piece 4 are electrically conductively connected to one another and therefore each have the same electrical potential. The first rated current contact piece 1 and the first arc contact piece 3 are each rigidly mounted. The whole interrupter unit is essentially designed to be rotationally symmetrical about the axis of rotation 5. An insulated nozzle 6, which encompasses the first arc contact piece 3 and is at least partially encompassed by the first rated current contact piece, is arranged coaxially with respect to the first rated contact current piece 1 and the first arc contact piece 3. The second rated current contact piece 2 and the second arc contact piece 4 are movable relative to the first rated current contact piece 1 and to the first arc contact piece 3. The second rated current contact piece 2 and the second arc contact piece 4 can be moved along the axis of rotation 5 for this purpose. In addition, the second arc contact piece 4, which is designed in the form of a bolt, is also movable relative to the second rated current contact piece 2. During a closing process, the arc contact pieces 3, 4 make contact first followed by the rated current contact pieces 1, 2. During an opening process, galvanic separation takes place first between the rated current contact pieces 1, 2 followed in time by separation between the arc contact pieces 3, 4. As a result of this switching behavior, switching arcs occur predominantly at the arc contact pieces 3, 4. In order in addition to have a positive effect on the switching behavior, that is to say in order to achieve a higher separating speed between the arc contact pieces 3, 4, the second arc contact piece 4 can additionally be driven separately and is movable relative to the second rated current contact piece 2.

The interrupter unit shown in FIG. 1 is surrounded by a fluid, preferably by an electron-negative gas such as sulfur hexafluoride or nitrogen for example. During a switching process, in particular an opening process, an arc occurs between the two arc contact pieces 3, 4, which heats and expands the gas. As a result, an increased gas pressure is produced in the vicinity of the separation point. Because of the increased gas pressure, heated gas, guided by the insulated nozzle 6, disperses in a first direction to the second arc contact piece 4. In order to allow the hot gas to disperse in a defined manner, a flow-conducting body 7 is arranged in the area of the second arc contact piece 4. The detailed design of the flow-conducting body 7 is shown in FIG. 2.

The second rated current contact piece 2 and the second arc contact piece 4 are shown in section in FIG. 2. A contact piece 9 is fixed to a carrier element 8. The contact piece 9 has a plurality of contact fingers, which are arranged coaxially with respect to the axis of rotation 5. The contact piece 9 is electrically conductively connected to the carrier element 8. The carrier element 8 has a galvanic connection to the second rated current contact piece 2 and therefore also has a connection to a contact point of the interrupter unit. Via this chain of galvanic connections and the contact fingers of the contact piece 9, which are in sliding elastic contact with the outer circumference of the second arc contact piece 4, the second arc contact piece 4 is also connected to the fixed contact point of the interrupter unit. A flow-conducting body 7 is provided in order to protect the contact piece 9 and the sliding contact arrangement between contact piece 9 and the second arc contact piece 4 against degradation due to switching gases, for example due to resistance-increasing deposits on the surface of the second arc contact piece 4. The flow-conducting body 7 has a first element 7a and a second element 7b. The first element 7a of the flow-conducting body 7 is designed essentially in the form of a hood and tapers conically at its end facing the first arc contact piece 3. The first element 7a is designed to be rotationally symmetrical and is arranged coaxially with respect to the axis of rotation 5. At the conically tapering tip, the first element 7a is provided with a through opening, through which the second arc contact piece 4 is movably guided. This opening serves as a sliding bearing for the second arc contact piece 4. At its end which faces the carrier element 8, the first element 7a has an internal thread, which is screwed onto an external thread 8a located on the carrier element 8. In the region of the internal thread, the first element 7a has a circumferential recess in which a ring-shaped circumferential projection of the contact piece 9 is placed. By means of the circumferential recess, the ring-shaped circumferential projection of the contact piece 9a is pressed against a contact surface of the carrier element 8 when the internal thread of the first element 7a is positively engaged with and securely screwed to the external thread 8a of the carrier element 8. As well as the first element 7a, the flow-conducting body 7 has a second element 7b, which is designed essentially in the form of an annular disk and is placed on the carrier element 8 by means of the annular opening. Openings, through which dispersing gas can flow, are provided in the annular area of the second element 7b. The flowing gas is guided toward these openings by the first element 7a and its conical shape. The path and the dispersal of the gas are controlled in conjunction with the first element 7a and the openings of the second element 7b, that is to say a defined quantity of gas is dispersed objectively, as a result of which the gas pressure is reduced in a staggered manner over a period of time. The second element 7b is made from a synthetic material. An example of this synthetic material is polytetrafluoroethylene.

A circumferential shoulder 10, which protrudes in a radial direction, is formed in the vicinity of the annular opening of the second element 7b reducing the annular opening. The second element 7b is fixed in a radial direction on the carrier element 8 by means of the shoulder 10. A further projecting shoulder 11 is formed on the annular opening of the second element 7b. However, this is not formed in a radial direction, but is formed coaxially with respect to the axis of rotation 5, so that this has the form of a projecting hollow cylindrical section. This projecting hollow cylindrical section projects into an annular circumferential slot 12 of the first element 7a so that in section a joint gap is produced, which starting from an outer surface initially runs in a radial direction, is then redirected and runs in the opposite direction in the first direction of the dispersing gas, and is then in turn redirected through twice 90 degrees so that afterwards the gap runs in the direction of the dispersing gas. At the tip of the further shoulder 11, the joint gap is redirected by 180 degrees. The joint gap is subjected to a further redirection of 180 degrees in the vicinity of the shoulder 10. Here, a hollow cylindrically shaped circumferential shoulder 13 is formed on the first element 7a in a similar manner to the further shoulder 11 of the second element 7b. A redirection of the joint gap by 180 degrees is in turn provided between the shoulder 13 and the shoulder 10.

A double S-shaped form of the joint gap is achieved in the section by the double redirection of the direction of the joint gap in the section by 180 degrees. This creates a labyrinthine structure, which performs alternate changes in direction in the manner of a meander.

In the vicinity of the walls bordering the joint gap in a radial direction, the joint gap has a smaller cross-section than in the redirection zones in which surfaces lying radially with respect to the axis of rotation 5 border the joint gap. This alternately increases and reduces the flow resistance for the gas penetrating the joint gap. In conjunction with the redirection, this brings about a cooling effect.

The second element 7b is frictionally held in position by means of frictional forces in the vicinity of the joint gap between the first element 7a and the second element 7b. If the materials used for the first and second element 7a, 7b are suitably matched and if the dimensions in the area of the section between the two elements 7a, 7b which is designed with a complementary shape are suitably matched, it can also be provided that the second element is mounted in a floating manner. As a result of the floating mounting, forces emanating from the gas flow are absorbed in an improved manner. This increases the elasticity of the whole arrangement. In this way, impacts in the synthetic material body of the second element 7b can be absorbed by elastic deformation. The comparatively rigid first element 7a, which is made from electrically conducting materials such as aluminum, electro-copper, copper chromium zirconium etc., is therefore protected from damage due to sudden pressure increases.

1-10. (canceled)

11. An interrupter unit of an electrical switching device, comprising:
having a flow-conducting body for guiding a gas dispersing in a first direction, said flow-conducting body being assembled from at least a first element and a second element;
said first and second elements being disposed to form a joint gap therebetween, said joint gap having a segment in which said first and second elements are formed with a complimentary shape to form a labyrinth structure.

12. The interrupter unit according to claim 11, wherein said segment is formed at least partially by a projection of said first element, which is surrounded by walls of said second element.

13. The interrupter unit according to claim 11, wherein said first and second elements are rotationally symmetrical bodies.

14. The interrupter unit according to claim 11, wherein a course of said joint gap is redirected by at least 180° in said segment.

15. The interrupter unit according to claim 14, wherein said joint gap has a lower thickness before and after the redirection than within the area of the at least 180° redirection.

16. The interrupter unit according to claim 11, wherein one of said first and second elements is configured to guide a movable contact piece of the interrupter unit.

17. The interrupter unit according to claim 11, wherein one of said first and second elements is formed substantially from an electrical insulator and another one of said first and second elements is formed substantially from an electrically conducting material.

18. The interrupter unit according to claim 11, wherein said joint gap is formed to undergo a dual redirection by at least 180° with regard to a sectional plane.

19. The interrupter unit according to claim 11, wherein said first element is connected to a carrier element while interposing a contact piece, wherein said second element is held positively locked between a carrier element and said first element by said joint gap.

20. The interrupter unit according to claim 19, wherein said second element is held floating in the positive lock.
